(19) United States
(12) Patent Application Publication
(10) Pub. No.: US 2012/0223002 A1
(43) Pub. Date: Sep. 6, 2012

(54) MODULAR FILTER CAPSULE APPARATUS

(76) Inventor: Zhenwu Lin, Bellevue, WA (US)

(21) Appl. No.: 13/401,866

(22) Filed: Feb. 22, 2012

Related U.S. Application Data
(60) Provisional application No. 61/446,487, filed on Feb. 24, 2011.

(51) Int. Cl. B01D 35/30; B01D 29/88

(52) U.S. Cl. 210/232; 210/444; 210/418

(57) ABSTRACT

Disclosed is a capsule apparatus having a filter housing defining a filter chamber with a top cap having a plurality of ports extending substantially laterally from a top end of the top cap to reduce the overall dimensions of the apparatus. The lateral and substantially uniform orientation of the ports facilitates connection to panel mount assemblies and improves filter maintenance processes. A transfer tube extending the length of the capsule allows the introduction of heated fluids from a top mounted inlet port to a bottom of the capsule chamber to allow or a substantially uniform heat gradient in the capsule filter chamber. An alternative shield secured in the housing defines a first chamber in fluid communication with an inlet and a second chamber wherein the two chambers are in fluid communication via an opening defined by a lower end of the shield and a bottom of the filter chamber.

### CROSS-REFERENCE TO RELATED APPLICATIONS

This application claims priority to U.S. Provisional Application Ser. No. 61/446,487 filed Feb. 24, 2011, the contents of which are incorporated in their entirety herein by reference.

### FIELD OF THE DISCLOSURE

The disclosure relates to filter capsules having housings used to enclose filters that separate and remove solid, liquid and/or gaseous contaminants and/or intermix and introduce one fluid or gas into a second fluid or gas. More particularly, the disclosure concerns filter housing and filter capsule inlet and outlet configurations to improve serviceability and adaptability to larger assemblies.

### BACKGROUND OF THE DISCLOSURE

To filter fluids and/or gases of undesired contaminants, filters are used in enclosed housings to effectuate contaminant removal. In a common filter capsule configuration, ports are positioned to occupy different planes or extend from the capsule in different directions, such as shown in published application No.: US 2010/0282665. In that application, the inlet and outlet ports are positioned at diametrically opposed locations at the top end of the capsule. This configuration requires a substantial amount of space within a larger assembly to receive the capsule and to secure the ports, which thereby limits the possible orientation variations when mounted to a panel. It further increases the effort needed to attach the capsule as connections have to be made at two entirely different locations. What is needed is a filter capsule having ports oriented to extend from a capsule in a uniform direction to reduce the space required for attachment to a larger assembly and to facilitate connection of tubes for the ingress and egress of desired fluids and/or gases.

A further problem associated with filter capsules is the common location of inlet ports at the top of the capsules. For the infusion of hot liquids, such as hot water for sanitation processes, a significant temperature gradient is created whereby the fluid in the top end of the capsule has a much higher temperature than the fluid located toward the bottom of the capsule. What is needed is an inlet system that originates from the top, but that directs incoming hot liquids to the bottom of the capsule to allow rising heat transfer in liquids and/or gases to create a significantly more uniform temperature gradient. These and other objects of the disclosure will become apparent from a reading of the following summary and detailed description of the disclosure as well as a review of the appended drawings.

### SUMMARY OF THE DISCLOSURE

In one aspect of the disclosure, an apparatus for enclosing filters includes a plurality of ports extending from a top end of a capsule whereby at least a portion of each port extends at an angle substantially orthogonal to the longitudinal axis of the capsule. Alternatively, the angle may deviate by about +/−30°, and as much as +/−45° from the orthogonal orientation. The ports are further oriented to extend from the capsule in the same general direction. Each port is dedicated to a particular function, e.g., inlet, outlet and vent.

In another aspect of the disclosure, the ports include quick coupling fittings to facilitate expedient, efficient and reliable connection and disassembly to larger assemblies or dedicated ingress or egress tubes. Each coupling may be configured as either a male or female fitting to accommodate a variety of connection configurations and requirements. Each coupling may further be configured to include a check valve integrated with either a male or female configured fitting.

In a yet further aspect of the disclosure, a fluid inlet is formed and positioned at a top end of a capsule. The inlet is connected to, and in fluid communication with, a proximal end of a transfer tube that extends from a top of the capsule to a point in close proximity to the bottom of the capsule. A distal end of the tube opens into the filter chamber and allows for the flow of fluids introduced into the tube to flow into the filter chamber from a bottom end of the chamber.

In a still further aspect of the disclosure, a filter capsule includes a cylindrical shield formed or placed inside the capsule between the capsule inner wall and a filter secured therein. The shield extends from substantially the top of the inner capsule to a point or plane in close proximity to, but not in substantial contact with, a bottom of the capsule so as to form a gap between a bottom edge of the shield and the inner wall of the capsule bottom. The shield combines with the capsule inner wall to form a first annular chamber that extends substantially from the inner top of the capsule to a point or plane in close proximity to, but not in contact with, the bottom of the capsule. A second annular chamber is formed between an inner wall of the shield and the enclosed filter. The gap formed at the bottom between the shield and the capsule bottom allows fluid communication between the chambers at the bottom of the capsule. An inlet configured on the capsule to be in fluid communication with the first chamber allows fluid to flow from the inlet down through the first annular chamber, through the gap and up into the second, filter-containing chamber.

In a yet further aspect of the disclosure, an apparatus for securing and containing a filter includes a capsule having a series of ports extending from a top end of the capsule. Each port is oriented to extend substantially along the longitudinal axis of the capsule. The ports are configured to extend in substantially the same direction so as to facilitate manual connection to larger assemblies including panel mounts. These and other aspects of the disclosure will become apparent from a review of the appended drawings and a reading of the following detailed description of the disclosure.

### BRIEF DESCRIPTION OF THE DRAWINGS

FIG. 1 is a side elevational view of a filter capsule according to one embodiment of the disclosure.

FIG. 2 is a bottom view of the filter capsule embodiment shown in FIG. 1.

FIG. 3 is a perspective view of the filter capsule embodiment shown in FIG. 1.

FIG. 4 is a side elevational view of a filter capsule according to another embodiment of the disclosure.

FIG. 5 is a sectional, perspective view of a filter capsule and port fittings according to one embodiment of the disclosure.

FIG. 6 is a sectional, perspective view of a filter capsule and port fittings according to another embodiment of the disclosure.

FIG. 7 is a sectional perspective view of a filter capsule and ports fittings according to a further embodiment of the disclosure.

FIG. 8 is a side elevational view of a filter capsule according to a further embodiment of the disclosure.

FIG. 9 is a bottom view of the filter capsule embodiment shown in FIG. 8.

FIG. 10 is a perspective view of the filter capsule embodiment shown in FIG. 8.

FIG. 11 is a sectional, perspective view of the filter capsule and port fittings according to the embodiment of the disclosure shown in FIG. 8.

### DETAILED DESCRIPTION OF THE DISCLOSURE

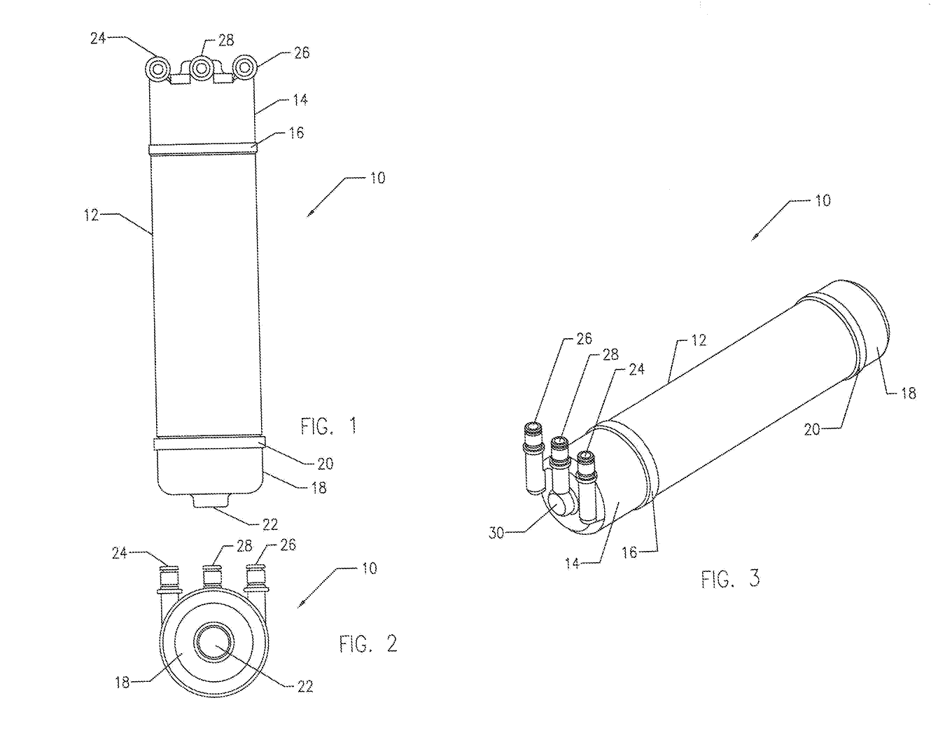

Referring to FIGS. 1-3 and 5-7, in one aspect of the disclosure, a filter capsule apparatus is shown generally as 10. Capsule 10 includes a substantially cylindrical body 12 that defines a generally hollow filter chamber configured to hold one or more filters 34. Capsule 10 may be formed in other regular or irregular geometric shapes to accommodate a wide variety of larger assembly configurations to which the capsule is attached and/or to accommodate a wide variety of filter shape configurations depending upon the application.

To enclose a proximal, top end of capsule 10, a top cap 14 having a substantially cylindrical shape conformed to the shape and dimensions of capsule body 12 and having an enclosed end and an opposing open end is thermally welded to the proximal end of body 12 to form a top cap joint 16. In an alternative embodiment, body 12 and top cap 14 may be formed with corresponding threaded surfaces or male/female segments as alternative means to secure top cap 14 to body 12. If snap-fit surfaces are used, sealing components, e.g., o-rings with corresponding mounting channels may be used to create an air/fluid tight seal. Adhesives, epoxies and the like may also be used to secure cap 14 to body 12.

Top cap 14 may be joined to body 12 before or after the installation of filters depending upon whether the other end of body 12 has been closed. In a further alternative embodiment, top cap 14 is formed together with body 12 in the same molding process. In this embodiment a bottom cap, disclosed below, is not formed in the same molding process as top cap 14 and capsule body 12.

To enclose a distal, bottom end of capsule body 12, a bottom cap 18 having a substantially cylindrical shape conformed to the shape and dimensions of body 12 and having an enclosed end and an opposing open end is thermally welded to the distal end of capsule 10 to form bottom cap joint 20. In an alternative embodiment, body 12 and bottom cap 18 may be formed with corresponding threaded surfaces or male/female segments as alternative means to secure bottom cap 18 to body 12. If snap-fit surfaces are used, sealing components, e.g., o-rings may be used to create an air/fluid tight seal. Adhesives, epoxies and the like may also be used to secure bottom cap 18 to body 12.

Bottom cap 18 may be joined to body 12 before or after the installation of filters depending upon whether the other end of body 12 has been closed. In a further alternative embodiment, bottom cap 18 is formed together with body 12 in the same molding process. In this embodiment, a top cap, disclosed above, is not formed in the same molding process as bottom cap 18 and capsule body 12.

Bottom cap 18 may be formed with a mounting post 22 configured to receive corresponding mounting appendages from a larger assembly such as a mounting panel. The combination of body 12, top cap 14 and bottom cap 18 form capsule 10.

In a further alternative embodiment, in place of mounting post 22, a drainage port may be formed in bottom cap 18 to allow fluids to be drained from the bottom end of capsule 10 without the need to engage a port formed in top cap 14 dedicated as an outlet port as more fully described below. The drainage port may be configured with a male or female connector end and may also include quick disconnect fittings and a modular or integrated check valve to prevent the unwanted flow of fluids and/or gases from the capsule.

Formed on, integral with, or appended to, top cap 14, are a plurality of ports configured for connection to, and to provide fluid communication with, fluid/gas delivery and/or extraction sources. The ports may be formed with appendages, annular channels, etc., to receive sealing components, e.g., o-rings. More specifically, a cannula-shaped, essentially hollow, inlet port 24 is formed on, or secured to, a lateral edge of top cap 14 to provide a means to infuse fluids and/or gases into the filter chamber formed within capsule 10. The location of the interface/juncture of inlet port 24 with top cap 14 may be positioned at other locations about the cap other than the lateral edge of top cap 14.

Inlet port 24 includes modular or integral male or female fittings to accommodate and receive corresponding fittings 38 of fluid delivery tubes or channels to allow fluids and/or gases to traverse the tube/port juncture in an essentially leak free, airtight manner. Inlet port 24 may also include an integral or modular check valve to prevent the release of fluids or spillage when capsule 10 is disassembled to remove, replace or service the internal filter(s).

Formed on, integral with, or appended to, a lateral edge of top cap 14 opposite the lateral edge occupied by inlet port 24 is a cannula-shaped, essentially hollow, vent port 28. Vent port 28 is formed on, or secured to, top cap 14 to provide a means of egress for unwanted fluids and/or gases present in the filter chamber defined by capsule 10. The location of the interface/juncture of outlet port 28 may be positioned at other locations about the cap other than a lateral edge of top cap 14.

Vent port 28 is initially opened to vent out resident gas when capsule 10 is being filled with the desired fluid and/or gas. Vent port 28 is otherwise closed during normal operation, or periodically opened for limited periods of time to allow the release of unwanted accumulated air and/or gas in the filter chamber.

Vent port 28 includes modular or integral male or female fittings to accommodate and receive corresponding fittings 38 of fluid receiving tubes or channels to allow fluids and/or gases to traverse the tube/port juncture in an essentially leak free, airtight manner. Vent port 28 may also include an integral or modular check valve to prevent the release of fluids or spillage when capsule 10 is disassembled to remove, replace or service the internal filter(s).

Also appended to top cap 14 is outlet port 26. Outlet port 26 may be formed on, integral with, or appended to, top cap 14 at essentially the center of cap 14. A cylindrical projection 30 may be formed as an interface between top cap 14 and outlet port 26. Projection 30 forms a chamber above the plane occupied by the top surface of top cap 14 that allows the flow of air, gas or fluids to collect in the chamber and migrate out of capsule 10 after being purified through the enclosed filter. It is particularly advantageous in fluid-based applications to allow the collection and elimination of any unwanted air and/or gas that may have entered the capsule. Should particulate matter pass through filter 34, chamber 30 provides an area for the particulate matter to collect so as to minimize any impediment the particulate matter may have on the egress of fluids and/or gases out of capsule 10.

This configuration further allows capsule 10 to be completely filled with a desired fluid and/or gas up to the highest point of the enclosed filter to ensure full utilization of the entire filter. In this manner, utilization of substantially the entire chamber area dedicated to housing one or more filters can be maximized for the intended purpose. Projection 30 further does not impact the overall capsule length as the desired length can be maintained by adjusting the outlet height to match the heights of the inlet and vent ports that may be longer when projection 30 is incorporated into top cap 14.

Outlet port 26 includes modular or integral male or female fittings to accommodate and receive corresponding fittings 38 of fluid receiving tubes or channels to allow fluids and/or gases to traverse the tube/port juncture in an essentially leak free, airtight manner. Outlet port 26 may also include an integral or modular check valve to prevent the release of fluids or spillage when capsule 10 is disassembled to remove, replace or service the internal filter(s).

It should be understood that the flow of fluids and/or gases through the various ports can be reversed without any reduction in function of the filter capsule. More specifically, what has been identified as inlet port 24 may function as an outlet port and what has been identified as outlet port 26 may function as an inlet port. In addition, what has been identified as vent port 28 may be utilized as either an inlet, or an outlet, port. The apparatus is designed to permit functional flow in either direction.

In this aspect of the disclosure, ports 24, 26, 28 are oriented in substantially the same plane wherein each port extends laterally from capsule 10 at an angle substantially orthogonal to a longitudinal axis of capsule 10. Alternatively, the ports may form an angle with the longitudinal axis about +/−30° from the orthogonal orientation. The ports may or may not occupy the same plane and instead, be offset to accommodate attachment to larger customized assemblies.

In a yet further alternative, each port may have a stem portion extending from top cap 14 substantially parallel with the longitudinal axis of capsule 10 and a distal portion continuous with the stem portion that deviates from the parallel orientation with the capsule longitudinal axis. The distal portion forms an angle with the stem portion wherein the distal portion occupies a plane substantially orthogonal to the capsule longitudinal axis. Alternatively, the distal portions may form an angle with the longitudinal axis of the capsule about +/−30° from the orthogonal orientation. The stem portion length can be varied to control the overall length of the capsule.

Referring again to the configuration wherein the ports extend laterally from the top cap 10, this configuration reduces the overall height of the apparatus to enable the apparatus to fit within tight dimensional portions of larger assemblies without any appreciable diminishment in the amount of capsule space dedicated to house one or more filters. The substantially unidirectional port orientation also facilitates installation onto, or into, larger assemblies, particularly panel mount assemblies, as all connection surfaces, i.e., ports face substantially the same direction. The addition of quick couplings further eases installation. A yet further advantage is experienced as the location of all the ports at substantially the highest point of capsule 10 allows for removal of the lower-positioned enclosed filters substantially without spillage.

In another aspect of the disclosure as shown in FIG. 6, a transfer tube 40 is formed integral with, or appended to, an inside wall of capsule 10 to provide a channel for delivering warm fluids and/or gases from a top end of capsule 10 to a bottom end of the capsule without requiring the fluid and/or gas to first migrate through the filter chamber. A top end of the transfer tube is connected to, and in fluid communication with, inlet port 24. If the middle port 26 should be designated as the inlet port, tube 40 would be connected to that port to provide the desired function described below. A bottom end of the transfer tube is open to, and in fluid communication with a bottom end of the filter chamber formed and defined by capsule 10.

As shown in FIG. 6, fluid introduced into the capsule via inlet port 24 flows to the bottom of capsule 10 via tube 40 and flows up through the annular space formed between the inner wall of capsule 10 and the outer cylindrical wall of filter 34. The fluid then traverses the filter toward the center of capsule 10 and up and out through outlet port 26. With this configuration, heated fluids or gases introduced into capsule 10 flow to the bottom of the capsule first before entering into the filter. In this manner, normal heat dynamics cause the heated fluids/gases to rise up the chamber and dissipate heat. The continual transfer of heated fluids/gases into the bottom of the capsule while previously introduced fluids exit transfer tube 40 and rise up the capsule creates a counter-current effect that minimizes the heat gradient differential from the top to the bottom of the capsule.

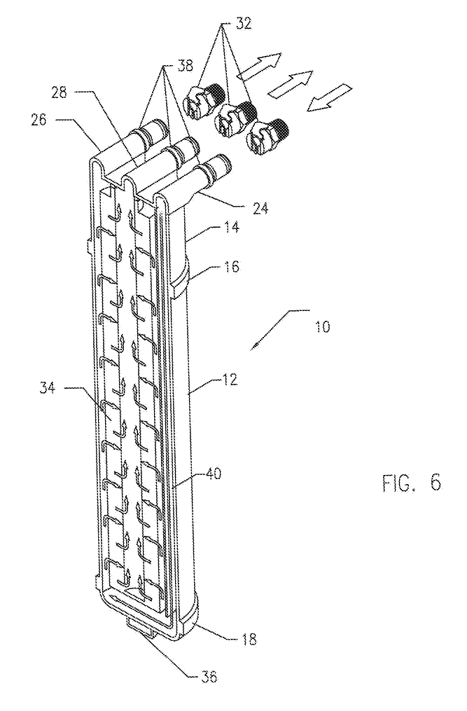

Without tube 40, fluid introduced into capsule 10 would follow the flow pattern illustrated in FIG. 5. The fluid would enter the capsule from the top, flow down the capsule via gravity feed and traverse filter 40 while flowing down the capsule. Once the fluid flowed through the filter, it would enter the center of capsule 10 and flow out outlet 26. In this configuration, any heated fluid introduced into the capsule would lose heat as it travels down the capsule and flows into filter 34. In doing so, a relatively large temperature gradient is created whereby the fluid at the top of capsule 10 would have a much higher temperature than the fluid at the bottom of capsule 10.

To achieve a specific fluid temperature or target temperature at the bottom of capsule 10, fluid introduced into the capsule from a top end would have to have a higher temperature than the target temperature to account for heat loss as the heat transfers to fluid toward the bottom of the capsule. This is particularly problematic when the fluid introduced into the capsule is intended to act as a cleaning fluid with a required temperature. This is further problematic due to the natural tendency of heated fluids to rise.

Use of transfer tube 40 substantially eliminates these problems by harnessing well known fluid thermal dynamic properties pursuant to which fluid seeks to reach thermal equilibrium by transferring heat from relatively high heat, relatively low density fluid to fluid having relatively low heat and relatively high density positioned at a higher elevation than the high heat fluid. These are the conditions extant in a filter capsule when fluid having relatively high heat and relatively low density is introduced into the bottom of the capsule. The heat transfers naturally and more efficiently when travelling from the bottom to the top of the capsule. In this manner, the fluid in the capsule is maintained at a much more uniform temperature along the entire length of the capsule as heat transfers up the enclosed fluid.

In an alternative embodiment, to further minimize the temperature gradient, a check valve can be formed integral to, or installed within a distal end of, transfer tube 40 to prevent backflow of the fluid and/or gas up the transfer tube and into inlet port 24. This ensures any heated fluid introduced into the capsule reaches the bottom of the capsule so as to maintain maximum heat efficiency.

In a further embodiment of the disclosure, the transfer tube is formed on an outside surface of capsule 10 A top end of the tube is connected to, and in fluid communication with, inlet port 24. A bottom end of the tube is connected to a bore formed in either a bottom end of capsule body 12, or a side wall of bottom cap 18 so as to provide fluid communication with the bottom interior of capsule 10.

With the use of the transfer tube, fluids and/or gases, and heated fluids and/or gasses in particular, can be introduced into the filter chamber at substantially the bottom-most end of the filter chamber to allow the heat introduced into the chamber to flow up into the higher layers of fluid and/or gas to ensure a relatively uniform temperature gradient. Prior art systems have the top-mounted inlet ports configured to channel fluids and/or gasses into the uppermost end of the filter chamber which causes the formation of substantial temperature gradients as the cooler, more dense fluid and/or gas tends to migrate to the bottom of the chamber while the hotter, less dense fluid and/or gas tends to remain in the upper end of the chamber.

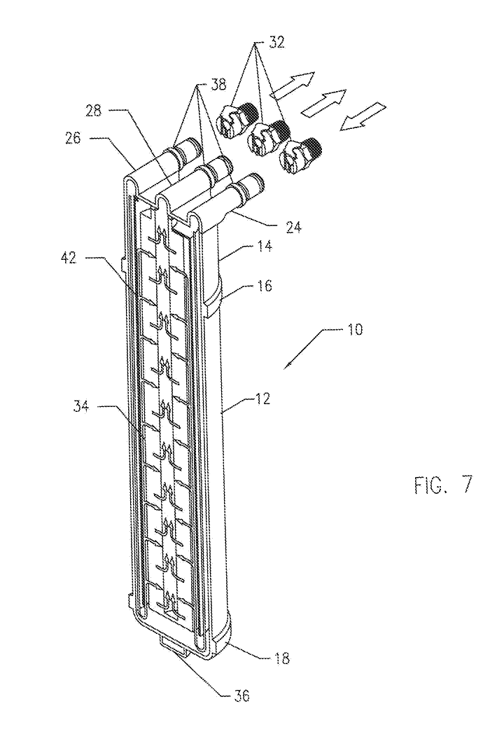

In another aspect of the disclosure as shown in FIG. 7, an encapsulating shield 42 is formed in the annular cavity between filter 34 and the inner wall of capsule 10. The upper end of shield 42 creates a partition between the three ports so that each is isolated from the others. A bottom end of shield 42 does not extend to the bottom of capsule 10 so as to provide a fluid path between the two annular chambers formed by the presence of shield 42. A first chamber 43 is formed between the inner wall of capsule 10 and the outer wall of shield 42. A second chamber 45 is formed between the inner wall of shield 42 and the outer wall of filter 34.

Fluid introduced into the capsule flows from the inlet port 24 into first annular chamber 43. The fluid flows down the first annular chamber until reaching the bottom of capsule 10. The flow then traverses the end of shield 42 and flows up into second annular chamber 45 from which the fluid enters into and traverses the filter. The fluid next flows out of the filter into the central chamber and out the outlet port 26. In this configuration, vent port 28 must be closed to ensure the flow follows the stated path through the annular chambers and out the outlet port.

The use of shield 42 established a countercurrent of flow that allows the some of the heat from the higher temperature fluid in first annular chamber to transfer through shield 42 into the upwardly flowing and lower-temperature fluid in second annular chamber 45. This heat exchange enables the fluid to achieve a relatively uniform temperature gradient as the highest temperature fluid at the very top in first chamber 43 will transfer heat to the coolest fluid at the top of second chamber 45. The next highest temperature fluid below the hottest fluid at the top will transfer heat to the next coolest level of fluid in the second chamber until the fluid reaches the bottom of the shield where the temperature of the fluid on either side of the bottom of shield 42 is approximately equivalent. If heat transfer through shield 42 is undesirable, shield 42 may be constructed from poor heat conducting materials as are well known in the art.

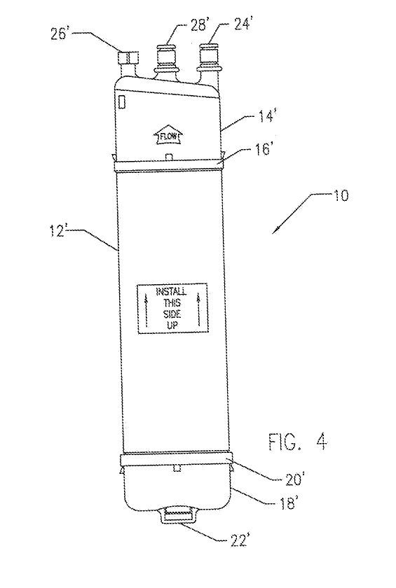

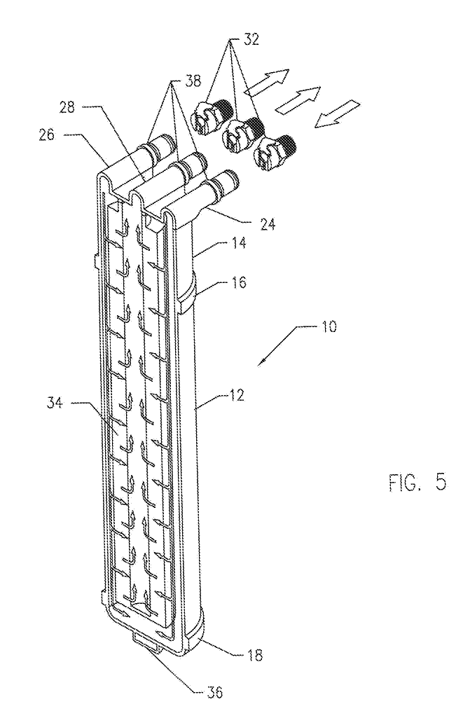

In a yet further aspect of the disclosure as shown in FIG. 4, a filter capsule 10′ is formed with, or has appended thereto, a plurality of ports that extend substantially upwardly from a top surface of a top cap 14′. It should be understood that elements referenced with primed numbers in one embodiment correspond to elements in other embodiments with the same unprimed or differently primed numbers. Capsule 10′ includes a substantially cylindrical body 12′ that defines a generally hollow filter chamber configured to hold one or more filters. Capsule 10′ may be formed in other regular or irregular geometric shapes to accommodate a wide variety of larger assembly configurations to which the capsule is attached and/or to accommodate a wide variety of filter shape configurations depending upon the application.

To enclose a proximal, top end of capsule body 12′, a top cap 14′ having a substantially cylindrical shape conformed to the shape and dimensions of capsule body 12′ and having one enclosed end and an opposing open end is thermally welded to the proximal end of capsule body 12′ to form a top cap joint 16′. In an alternative embodiment, capsule body 12′ and top cap 14′ may be formed with corresponding threaded surfaces or male/female segments as alternative means to secure top cap 14′ to capsule body 12′. If snap-fit surfaces are used, sealing components, e.g., o-rings may be used to create an air/fluid tight seal. Top cap 14′ may be joined to capsule body 12′ before or after the installation of filters depending upon whether the other end of capsule 10′ has been closed.

To enclose a distal, bottom end of capsule 10′, a bottom cap 18′ having a substantially cylindrical shape conformed to the shape and dimensions of capsule body 12′ and having an enclosed end and an opposing open end is thermally welded to the distal end of capsule body 12′ to form bottom cap joint 20′. In an alternative embodiment, capsule body 12′ and bottom cap 18′ may be formed with corresponding threaded surfaces or male/female segments as alternative means to secure bottom cap 18′ to capsule body 12′. If snap-fit surfaces are used, sealing components, e.g., o-rings may be used to create an air/fluid tight seal. Like top cap 14′, bottom cap 18′ may be joined to capsule body 12′ before or after installation of filters depending upon whether the other end of capsule 10′ has been closed. Bottom cap 18′ may be formed with a mounting post 22′ configured to receive corresponding mounting appendages from a larger assembly such as a mounting panel.

In an alternative embodiment, in place of mounting post 22′, a drainage port may be formed in bottom cap 18′ to allow fluids to be drained from the bottom end of capsule 10′ without engaging a port formed in top cap 14′ dedicated as an outlet port as more fully described below. The drainage port may be configured as a male or female connector and may also include quick disconnect fittings and a modular or integrated check valve.

Formed on, or appended to, top cap 14′, are a plurality of ports configured to provide fluid communication with fluid delivery or extraction sources. A cannula-shaped inlet port 24′ is essentially hollow and formed on, or secured to, a lateral edge of top cap 14′ to provide a means to infuse fluids and/or gases into the filter chamber contained in capsule 10′. The location of the interface/juncture of inlet port 24′ may be positioned at other locations other than a lateral edge of top cap 14′.

Inlet port 24′ includes modular or integral male or female fittings to accommodate and receive corresponding fittings of fluid delivery tubes or channels to allow fluids and/or gases to traverse the tube/port juncture in an essentially leak free, airtight manner. Inlet port 24′ may also include an integral or modular check valve to prevent the release of fluids or spillage when capsule 10′ is disassembled to remove, replace or service the internal filter(s).

Formed on, or appended to, a lateral edge of top cap 14′ opposite the lateral edge occupied by inlet port 24′ is a cannula-shaped vent port 26′. Vent port 28′ is essentially hollow and formed on, or secured to, top cap 14 to provide a means of egress for undesired fluids and/or gases present in the filter chamber contained in capsule 10′. It also provides a means to register the internal pressure of capsule 10′ to ambient pressure conditions. The location of the interface/juncture of vent port 26′ may be positioned at other locations other than a lateral edge of top cap 14′.

Vent port 26′ includes modular or integral male or female fittings to accommodate and receive corresponding fittings of fluid receiving tubes or channels to allow fluids and/or gases to traverse the tube/port juncture in an essentially leak free, airtight manner. Vent port 26′ may also include an integral or modular check valve to prevent the release of fluids or spillage when capsule 10′ is disassembled to remove, replace or service the internal filter(s).

Also appended to top cap 14′ is a cannula-shaped outlet port 28′. Outlet port 28′ may be formed on, or appended to, top cap 14′ at essentially a center of cap 14′. A cylindrical projection 30′ may be formed as an interface between top cap 14′ and outlet port 28′. Projection 30′ provides an enclosed area above the plane of top cap 14′ to allow air, or other unwanted substances or gases to rise and concentrate for release through outlet port 28′. This configuration allows capsule 10′ to be completely filled with a desired fluid and/or gas without compromising any area of the chamber formed by capsule 10′ dedicated to housing filters in a desired fluid and/or gas.

Outlet port 28′ includes modular or integral male or female fittings to accommodate and receive corresponding fittings of fluid receiving tubes or channels to allow fluids and/or gases to traverse the tube/port juncture in an essentially leak free, airtight manner. Outlet port 28′ may also include an integral or modular check valve to prevent the release of fluids or spillage when capsule 10′ is disassembled to remove, replace or service the internal filter(s).

In this aspect of the disclosure, ports 24′, 26′, 28′ are oriented in substantially the same plane wherein each port extends vertically or upwardly from capsule 10′ wherein the occupied plane by the ports is substantially parallel to a longitudinal axis of capsule 10′. Alternatively, the ports may occupy a plane that forms an angle with the longitudinal axis that is about +/−45° from the parallel orientation. In a further alternative embodiment, the ports may or may not occupy the same plane and instead, be offset to accommodate attachment to larger customized assemblies.

This configuration with substantially uniform port orientations whereby the ports extend substantially vertically from the top of capsule 10′ does not reduce the overall height of the apparatus, but facilitates the manual connection to mated fittings when the mated fittings are not panel mounted. The addition of quick couplings further eases installation. And the location of all the ports at substantially the highest point of capsule 10′ allows for removal of the contained filters without spillage.

In another aspect of the disclosure, a transfer tube 40′ is formed integral with, or appended to, an inside wall of capsule 10′ to provide a channel for delivering warm fluids and/or gases from a top end of capsule 10′ to a bottom end of capsule 10′ without requiring the fluid and/or gas to flow through the filter chamber. A top end of the transfer tube is connected to, and in fluid communication with, inlet port 24′. A bottom end of the transfer tube is open to, and in fluid communication with, a bottom end of the filter chamber formed by capsule 10′. In an alternative embodiment, a check valve can be formed integral to, or installed within a distal end of transfer tube 40′ to prevent backflow of the fluid and/or gas up the transfer tube and into inlet port 24′.

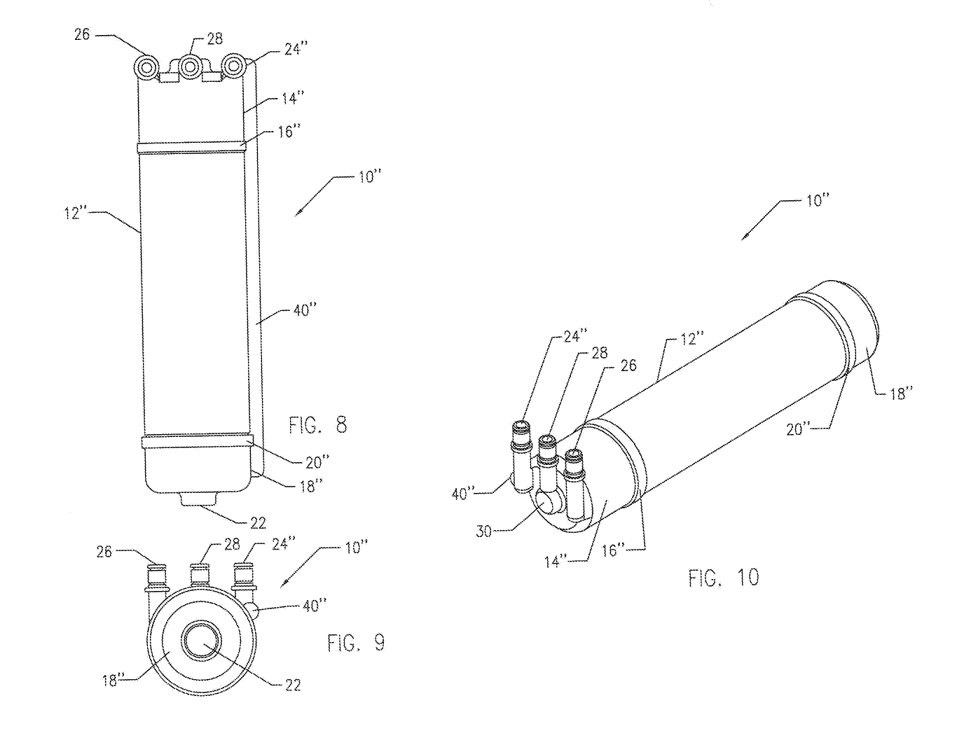

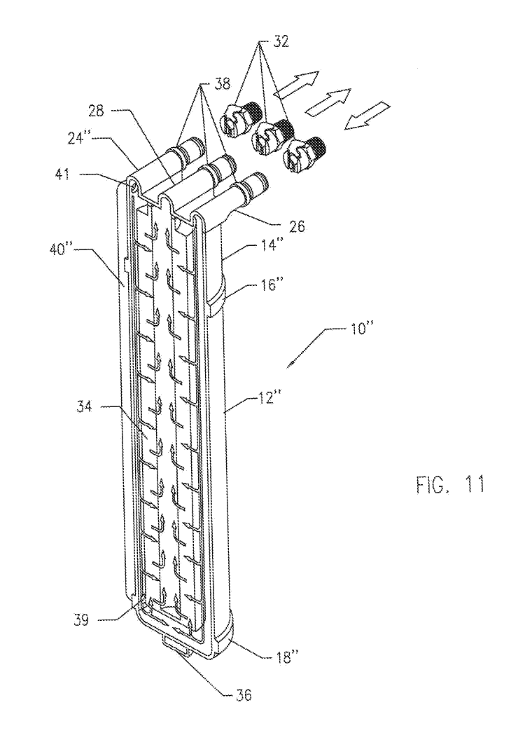

In a further embodiment of the disclosure, as shown in FIGS. 8-11, an exterior transfer tube 40″ is formed on an outside surface of a capsule 10″. A top end of the tube is connected to, and in fluid communication with, an inlet port 24″ via a top bore 41. A bottom end of the tube is connected to a bore 39 formed in either a bottom end of capsule 10″, or a side wall of a bottom cap 18″ so as to provide fluid communication with the interior of capsule 10″.

With the use of external transfer tube 40″, fluids and/or gases, and heated fluids and/or gasses in particular, can be introduced into the filter chamber at substantially the bottom most end of the filter chamber to harness the natural tendency of heated, and therefore, less dense, fluids and/or gases to rise so as to allow the heat introduced into the chamber to transfer up into the higher layers of fluid and/or gas to ensure a relatively uniform temperature gradient. Prior art systems have the top mounted inlet ports channeling fluids and/or gasses into the uppermost end of the filter chamber that causes substantial temperature gradients to form as the cooler fluid and/or gas tends to migrate to the bottom of the chamber while the hotter fluid and/or gas tends to remain in the upper end of the chamber.

In a yet further aspect of the disclosure, an RFID chip 36 is attached to, or embedded in, a bottom portion of bottom cap 18. In an alternative embodiment, the bottom of capsule 10 is formed as an integral part of the capsule with chip 36 embedded in the capsule forming material during manufacture. Chip 36 is embedded so as not to have any exposure to fluid or gas either inside or outside capsule 10, and to ensure the chip is not lost or improperly replaced with an unauthorized chip such as is possible with chips secured to items with adhesive and the like. Chip 36 is configured to endure high temperature environments and is rated for high temperatures. With this configuration, chip 36 can be exposed to the high temperatures of hot water sanitation processes.

The capsules, caps and ports described herein may be constructed from high heat resilient plastics, such as polypropylene, polyethylene, nylon, PFA and the like. The materials are used in conventional injection molding processes to create the capsules and related components. A key consideration for material selection is the material's ability to withstand high heat environments such as those found in sterilization equipment and autoclaves, as well as other sterilization means like gamma irradiation.

The quick couplings are configured to be compatible with coupling components manufactured and sold by, by way of example and not limitation, Linktech (Ventura, Calif.), Colder Plastics Company (St. Paul, Minn.) and John Guest Corp. (Fairfield, N.J.). The check valves may be of any conventional variety known in the art that ensures one-way flow of fluids and/or gases that flow through the capsules. Examples include those sold by the aforementioned companies. It should further be understood that the male/female configuration of the set of quick-connect couplings incorporated onto a capsule may be all male, all female, or a combination of both depending upon the particular application.

While the present disclosure has been described in connection with several embodiments thereof, it will be apparent to those skilled in the art that many changes and modifications may be made without departing from the true spirit and scope of the present disclosure. Accordingly, it is intended by the appended claims to cover all such changes and modifications as come within the true spirit and scope of the disclosure.

What I claim as new and desire to secure by United States Letters Patent is:

1. A filter capsule apparatus comprising:
a container having portions defining a filter chamber:
a filter secured in the chamber;
a top cap secured to a top end of the container;
a plurality of ports including an inlet port extending from the top cap, and,
a transfer tube extending along the length of the container wherein a first end is secured to, and in fluid communication with, the inlet port and a second end is secured in close proximity to the bottom of the container, and wherein the second end is in fluid communication with the chamber.

2. The filter capsule of claim 1 wherein the plurality of ports extend from the top cap in a uniform direction.

3. The filter capsule of claim 2 wherein the plurality of ports occupy substantially the same plane wherein the plane is parallel to a longitudinal axis of the container.

4. The filter capsule of claim 2 wherein the plurality of ports occupy substantially the same plane wherein the plane is substantially orthogonal to a longitudinal axis of the container.

5. The filter capsule of claim 2 wherein the plurality of ports occupy substantially the same plane wherein the plane is ^{+/-}45° from a plane orthogonal to a longitudinal axis of the container.

6. The filter capsule of claim 4 wherein at least one of the plurality of ports has a quick connect connector secured to the one port.

7. The filter capsule of claim 4 wherein each of the plurality of ports has an integral quick connect connector.

8. The filter capsule of claim 4 wherein at least one port of the plurality of ports has a check valve secured to the one port.

9. The filter capsule of claim 4 wherein each of the plurality of ports has a dedicated check valve secured thereto.

10. The filter capsule of claim 1 wherein the transfer tube is secured to an inner wall of the container.

11. The filter capsule of claim 1 wherein the transfer tube is secured to an outer wall of the container.

12. The filter capsule of claim 1 further comprising an RFID chip secured to the container.

13. The filter capsule of claim 1 further comprising an RFID chip embedded in material forming the container.

14. The filter capsule of claim 1 wherein the top cap has portions defining a projection chamber, wherein the projection chamber is in fluid communication with one of the plurality of ports.

15. The filter chamber of claim 1 further comprising a mounting port formed on a bottom of the container.

16. A filter capsule apparatus comprising:
a container having portions defining a filter chamber;
a filter secured in the chamber;
a bottom cap secured to a bottom end of the container;
a top cap secured to a top end of the container;
a plurality of ports including an inlet port extending from a top end of the top cap, and,
a shield secured in the chamber wherein the shield extends from a top end of the chamber to a plane proximal to a bottom end of the chamber wherein an inner wall of the container in combination with an outer wall of the shield defines a first chamber in fluid communication with the inlet port, wherein an inner wall of the shield in combination with an outer surface of the filter defines a second chamber, and wherein the first chamber and the second chamber are in fluid communication via an opening defined by the combination of the bottom of the chamber and a bottom edge of the shield.

17. The filter capsule of claim 16 wherein the plurality of ports extend from the top cap in a uniform direction.

18. The filter capsule of claim 17 wherein the plurality of ports occupy substantially the same plane wherein the plane is parallel to a longitudinal axis of the container.

19. The filter capsule of claim 17 wherein the plurality of ports occupy substantially the same plane wherein the plane is substantially orthogonal to a longitudinal axis of the container.

20. The filter capsule of claim 17 wherein the plurality of ports occupy substantially the same plane wherein the plane is +/−45° from a plane orthogonal to a longitudinal axis of the container.

21. The filter capsule of claim 17 wherein at least one of the plurality of ports has a quick connect connector secured to an end of the at least one port.

22. The filter capsule of claim 17 wherein at least one of the plurality of ports has an integral quick connect connector.

23. The filter capsule of claim 17 wherein at least one port of the plurality of ports has a check valve secured to the one port.

24. The filter capsule of claim 17 wherein each of the plurality of ports has a dedicated check valve secured thereto.

25. The filter capsule of claim 16 further comprising an RFID chip secured to the container.

26. The filter capsule of claim 16 further comprising an RFID chip embedded in material forming the container.

27. The filter capsule of claim 16 wherein the top cap has portions defining a projection chamber, wherein the projection chamber is in fluid communication with one of the plurality of ports.
